(19) United States
(12) Patent Application Publication
(10) Pub. No.: US 2022/0045389 A1
(43) Pub. Date: Feb. 10, 2022

(54) ELECTROLYTE FOR LITHIUM AIR BATTERIES, AND LITHIUM AIR BATTERY USING THE SAME

(71) Applicant: NATIONAL INSTITUTE FOR MATERIALS SCIENCE, Ibaraki (JP)

(72) Inventor: Shoichi MATSUDA, Ibaraki (JP)

(73) Assignee: NATIONAL INSTITUTE FOR MATERIALS SCIENCE, Ibaraki (JP)

(21) Appl. No.: 17/299,215

(22) PCT Filed: Oct. 28, 2019
(86) PCT No.: PCT/JP2019/042089

§ 371 Date: Jun. 2, 2021

(30) Foreign Application Priority Data
Jan. 4, 2019 (JP) 2019-000026

(51) Int. Cl. H01M 12/02; H01M 4/38

(52) U.S. Cl. CPC H01M 12/02; H01M 2300/0028; H01M 4/382

(57) ABSTRACT

The invention has for its object to provide an electrolyte capable of improving the energy efficiency of a lithium air battery, and a lithium air battery making use of the same. The electrolyte for a lithium air battery according to the invention contains an organic solvent that is a phosphoric acid ester having chemical formula (1) and/or a phosphonic acid ester having chemical formula (2), and lithium nitrate, wherein the concentration of lithium nitrate in the organic solvent satisfies a range of 2 mol/L to 5.5 mol/L inclusive. Preferably, the concentration of lithium nitrate in the organic solvent should satisfy a range of 3 mol/L to 5.5 mol/L inclusive.

### CROSS-REFERENCE TO THE RELATED APPLICATIONS

This is National Stage Application of International Patent Application No. PCT/JP2019/042089 claiming priority to Japanese Patent Application No. 2019-000026 filed on Jan. 4, 2019. The entire contents of Japanese Patent Application No. 2019-000026 are incorporated herein by reference.

### TECHNICAL FIELD

The present invention relates to an electrolyte for lithium air batteries, and a lithium air battery using the same.

### BACKGROUND ART

An air battery comprises an air electrode, a metallic negative electrode consisting of a metallic foil or metallic fine particles, and a liquid or solid electrolyte, wherein air or oxygen gas flowing through a gas passage provided in the air battery is used as a positive electrode active substance and the metallic foil or fine particles are used as a negative electrode active substance.

While multiple air battery technologies have been proposed in the art, research and development of lithium air batteries recently becomes brisk. The reasons are that an air battery is not only assembled into a chargeable, repeatedly usable secondary battery but also much more improved in terms of energy density per unit weight as compared with lithium ion batteries already put to practical use. However, a problem with the lithium air battery is that the energy efficiency is low due to higher charge voltage than discharge voltage.

To provide a solution to this problem, there is an air primary battery developed in which an electrolyte layer contains a low reduction-resistant solvent such as phosphoric acid esters (see, e.g., Patent Publication 1). Patent Publication 1 discloses an air primary battery comprising an air electrode using oxygen as an active substance, a negative electrode containing a negative electrode active substance out of which metal ions are releasable, and an electrolyte layer sandwiched between the air electrode and the negative electrode, characterized in that the electrolyte layer contains a low reduction-resistant solvent having higher reactivity to oxygen than reactivity of metal ions to oxygen, and when the total amount of a solvent contained in the electrolyte layer is presumed to be 100% by volume, the proportion of the low reduction-resistant solvent contained is 40% by volume or higher. Further, Patent Publication 1 discloses that phosphoric acid esters are used as the low reduction-resistant solvent, and states that LiNO₃ may possibly be used as a supporting electrolyte salt when the air primary battery is assembled into a lithium air battery. According to Example 5 or 7 of Patent Publication 1, however, there is only an electrolyte layer practically used in which trimethyl phosphate (TMP) or triethyl phosphate (TEP) is used as the phosphoric acid ester and LiN(SO₂CF₃)₂ is used as the supporting electrolyte salt. Although the air battery using such an electrolyte layer is somewhat improved in terms of discharge capacity, far more is still desired.

### PRIOR ARTS

### Patent Publications

Patent Publication 1: JP(A) 2012-174349

### SUMMARY OF THE INVENTION

### Object of the Invention

As can be understood from the foregoing, the present invention has for its object to provide an electrolyte capable of enhancing the energy efficiency of a lithium air battery, and a lithium air battery assembled using the same.

### EMBODIMENTS OF THE INVENTION

An electrolyte for lithium air batteries according to the present invention contains an organic solvent that is a phosphoric acid ester and/or a phosphonic acid ester, and lithium nitrate, characterized in that a concentration of the lithium nitrate in the organic solvent satisfies a range of 2 mol/L to 5.5 mol/L inclusive, the phosphoric acid ester is represented by the following chemical formula (1), and the phosphonic acid ester is represented by the following chemical formula (2), thereby providing a solution to the aforesaid problem.

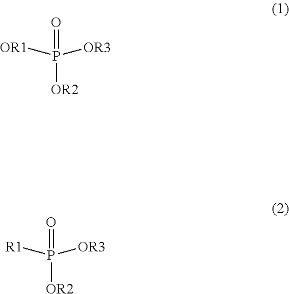

where R1, R2 and R3 are each independently a group selected from the group consisting of a linear alkyl group having one to three carbon atoms, a linear alkenyl group having two or three carbon atoms, an alkynyl group having two or three carbon atoms, and a derivative thereof.

In one embodiment of the invention, the concentration of the lithium nitrate in the organic solvent may satisfy a range of 3 mol/L to 5.5 mol/L inclusive.

In one embodiment, the concentration of the lithium nitrate in the organic solvent may satisfy a range of 4 mol/L to 5 mol/L inclusive.

In one embodiment, the alkyl group may be selected from the group consisting of a methyl group, an ethyl group, and an n-propyl group; the alkenyl group may be a vinyl group or an allyl group; and the alkynyl group may be an ethynyl group or a propargyl group.

In one embodiment, the phosphoric acid ester may be an at least one selected from the group consisting of trimethyl phosphate, triethyl phosphate, tripropyl phosphate, trivinyl phosphate, triallyl phosphate, triethynyl phosphate, tripropargyl phosphate, and a derivative thereof.

In one embodiment, the phosphoric acid ester may be at least one selected from the group consisting of triethyl phosphate, tripropyl phosphate, and a derivative thereof.

In one embodiment, the phosphonic acid ester may be at least one selected from the group consisting of dimethyl methylphosphonate, diethyl methylphosphonate, dipropyl methylphosphonate, divinyl methylphosphonate, diallyl methylphosphonate, diethynyl methylphosphonate, dipropargyl methylphosphonate, dimethyl ethylphosphonate, diethyl ethylphosphonate, dipropyl ethylphosphonate, divinyl ethylphosphonate, diallyl ethylphosphonate, diethynyl ethylphosphonate, dipropargyl ethylphosphonate, dimethyl propylphosphonate, diethyl proylphosphonate, dipropyl propylphosphonate, divinyl propylphosphonate, diallyl propylphosphonate, diethynyl propylphosphonate, dipropargyl propylphosphonate, dimethyl vinylphosphonate, diethyl vinylphosphonate, dipropyl vinylphosphonate, divinyl vinylphosphonate, diallyl vinylphosphonate, diethynyl vinylphosphonate, dipropargyl vinylphosphonate, dimethyl allylphosphonate, diethyl allylphosphonate, dipropyl allylphosphonate, divinyl allylphosphonate, diallyl allylphosphonate, diethynyl allylphosphonate, dipropargyl allylphosphonate, and derivatives thereof.

In one embodiment, the phosphonic acid ester may be at least one selected from the group consisting of diethyl methylphosphonate, diethyl ethylphosphonate, and a derivative thereof.

In one embodiment, the water contained in the electrolyte may be up to 100 ppm.

In one embodiment, the electrolyte may have a viscosity ranging from 0.1 Pa·s to 10 Pa·s inclusive.

In one embodiment, the lithium air battery disclosed herein comprises an air electrode, a metallic negative electrode including a lithium metal, and a non-aqueous electrolyte positioned between the air electrode and the metallic negative electrode, wherein the non-aqueous electrolyte comprises the aforesaid electrolyte thereby providing a solution to the aforesaid problem.

In one embodiment, the lithium air battery disclosed herein may comprise a separator between the air electrode and the metallic negative electrode, the non-aqueous electrolyte between the metallic negative electrode and the separator, and the non-aqueous electrolyte or an aqueous electrolyte between the air electrode and the separator.

### Advantages of the Invention

The electrolyte for lithium air batteries according to the invention contains an organic solvent that is a phosphoric acid ester and/or a phosphonic acid ester, and lithium nitrate, and the concentration of lithium nitrate in the organic solvent is adjusted in such a way as to satisfy the range of 2 mol/L to 5.5 mol/L inclusive. Further, the phosphoric acid ester and phosphonic acid ester are defined by the aforesaid chemical formulae (1) and (2), respectively. The inventor has found that a specific organic solvent that is a phosphoric acid ester and/or a phosphonic acid ester and lithium nitrate are selected from a variety of organic solvents and supporting salts to prepare an electrolyte having a concentration in the given range so that especially when the supporting salt is in a high concentration range, the energy efficiency of a lithium air battery is much more enhanced. Selection of a given organic solvent and a given supporting salt and adjustment of an electrolyte concentration are all that is needed to enhance energy efficiency. This is advantageous as it facilitates installation of a lithium air battery.

### BRIEF EXPLANATION OF THE DRAWINGS

FIG. 1 is a schematic view of the arrangement of a lithium air battery according to one embodiment of the invention.

FIG. 2 is a schematic view of the arrangement of a lithium air battery according to another embodiment of the invention.

FIG. 3 is indicative of the charge/discharge cycle characteristics of the lithium air battery according to Example 1.

FIG. 4 is indicative of the charge/discharge cycle characteristics of the lithium air battery according to Example 2.

FIG. 5 is indicative of the charge/discharge cycle characteristics of the lithium air battery according to Example 3.

FIG. 6 is indicative of the charge/discharge cycle characteristics of the lithium air battery according to Example 4.

FIG. 7 is indicative of the charge/discharge cycle characteristics of the lithium air battery according to Example 5.

FIG. 8 is indicative of the charge/discharge cycle characteristics of the lithium air battery according to Example 6.

FIG. 9 is indicative of the charge/discharge cycle characteristics of the lithium air battery according to Example 7.

FIG. 10 is indicative of the charge/discharge cycle characteristics of the lithium air battery according to Example 8.

FIG. 11 is indicative of the charge/discharge cycle characteristics of the lithium air battery according to Example 10.

FIG. 12 is indicative of the charge/discharge cycle characteristics of the lithium air battery according to Example 12.

FIG. 13 is indicative of the charge/discharge cycle characteristics of the lithium air battery according to Example 13.

FIG. 14 is indicative of the charge/discharge cycle characteristics of the lithium air battery according to Example 14.

FIG. 15 is indicative of the charge/discharge cycle characteristics of the lithium air battery according to Example 15.

FIG. 16 is indicative of the charge/discharge cycle characteristics of the lithium air battery according to Example 16.

FIG. 17 is indicative of the charge/discharge cycle characteristics of the lithium air battery according to Example 17.

FIG. 18 is indicative of capacity changes at 4.2 V upon charging of a lithium air battery using an electrolyte comprising a combination of TEP with a variety of lithium salts.

FIG. 19 is indicative of capacity changes at 4.2 V upon charging of a lithium air battery using an electrolyte comprising a combination of each of DEMP, DEEP, TEP and TPP with lithium nitrate.

FIG. 20(A) is indicative of a charge curve for the lithium air battery according to Example 2.

FIG. 20(B) is indicative of results of mass spectrometry of gases generated via charging reaction.

### MODES FOR IMPLEMENTING THE INVENTION

Some modes for implementing or carrying out the invention are now explained with reference to the accompanying drawings in which, unless otherwise stated, like numeral references refer to like elements.

### (Implementation Mode 1)

The electrolyte for lithium air batteries according to the invention, and the process for producing the same will now be explained with reference to Implementation Mode 1.

For an electrolyte for lithium air batteries, the inventor has directed attention to a water-free or non-aqueous electrolyte in which a phosphoric acid ester or phosphonic acid ester is used as the organic solvent. It has consequently been found that proper selection of a specific phosphoric acid ester and/or a specific phosphonic acid ester together with a lithium salt and adjustment of their concentration in a specific range could contribute more to enhancements in the energy efficiency of a lithium air battery.

The electrolyte for lithium air batteries according to the invention contains an organic solvent that is a phosphoric acid ester and/or a phosphonic acid ester, and lithium nitrate. It is here understood that the phosphoric acid ester is represented by the following chemical formula (1), and the phosphonic acid ester is represented by the following chemical formula (2).

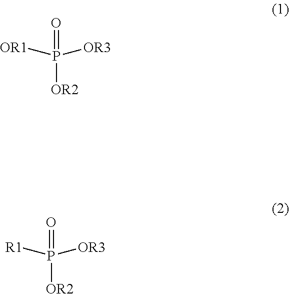

It is here noted that R1, R2 and R3 are each independently a group selected from the group consisting of a linear alkyl group having one to three carbon atoms, a linear alkenyl group having two or three carbon atoms, an alkynyl group having two or three carbon atoms, and a derivative thereof. As the number of carbon atoms is more than 3, it may often cause lithium nitrate to be insoluble in the organic solvent. The derivative may have a functional group such as hydroxyl or nitro groups introduced therein or, alternatively, its hydrogen atom may be substituted by chlorine or the like, to such an extent as to give rise to no or little structural change or denaturation. R1, R2 and R3 may be identical with or different from one another.

More specifically, the linear alkyl group having 1 to 3 carbon atoms is a methyl group, an ethyl group, and an n-propyl group; the linear alkenyl group having 2 or 3 carbon atoms is a vinyl group, and an allyl group; and the alkynyl group having 2 or 3 carbon atoms is an ethynyl group, and a propargyl group.

From experimentation, the inventor has found that only the aforesaid phosphoric acid ester and phosphonic acid ester out of a variety of phosphoric acid esters and phosphonic acid esters are effective.

In the electrolyte for lithium air batteries according to the invention, the concentration of lithium nitrate in the organic solvent is adjusted in such a way as to satisfy the range of 2 mol/L to 5.5 mol/l inclusive. As the concentration of lithium nitrate is less than 2 mol/L, it often results in insufficient improvements in the energy efficiency of a lithium air battery, and as the concentration of lithium nitrate is greater than 5.5 mol/L, it makes lithium nitrate insoluble in the organic solvent.

Among lithium salts, usually, lithium nitrate is low in terms of the degree of dissociation relative to an organic solvent; it is used in the form of an aqueous electrolyte. Even when lithium nitrate is used in the form of a non-aqueous electrolyte, it is often used in a concentration of about 1 mol/L. The reason is that the conductivity of lithium would conventionally reach a maximum in that concentration. From extensive experiments, however, the inventor has found out that when using the organic solvent that is the aforesaid phosphoric acid ester and/or phosphonic acid ester, lithium nitrate dissolves in a high concentration without recourse to water, making it possible to enhance the energy efficiency of a lithium air battery.

The concentration of lithium nitrate is preferably in the range of 3 mol/L to 5.5 mol/L inclusive, which contributes more to effective improvements in the energy efficiency of a lithium air battery. More preferably, the concentration of lithium nitrate is in the range of 4 mol/L to 5 mol/L inclusive, ensuring that the energy efficiency of a lithium air battery can be much more improved.

With availability and yields in mind, the phosphoric acid ester having the aforesaid formula (1) preferably includes at least one selected from the group consisting of trimethyl phosphate, triethyl phosphate, tripropyl phosphate, trivinyl phosphate, triallyl phosphate, triethynyl phosphate, tripropargyl phosphate, and a derivative thereof, but not limited thereto with the proviso that formula (1) is met. Among others, at least one selected from the group consisting of triethyl phosphate, tripropyl phosphate, and a derivative thereof is most preferable, contributing more to further improvements in the energy efficiency of a lithium air battery.

With availability and yields in mind, the phosphonic acid ester having the aforesaid formula (2) preferably includes at least one selected from the group consisting of dimethyl methylphosphonate, diethyl methylphosphonate, dipropyl methylphosphonate, divinyl methylphosphonate, diallyl methylphosphonate, diethynyl methylphosphonate, dipropargyl methylphosphonate, dimethyl ethylphosphonate, diethyl ethylphosphonate, dipropyl ethylphosphonate, divinyl ethylphosphonate, diallyl ethylphosphonate, diethynyl ethylphosphonate, dipropagyl ethylphosphonate, dimethyl propylphosphonate, diethyl proylphosphonate, dipropyl propylphosphonate, divinyl propylphosphonate, diallyl propylphosphonate, diethynyl propylphosphonate, dipropargyl propylphosphonate, dimethyl vinylphosphonate, diethyl vinylphosphonate, dipropyl vinylphosphonate, divinyl vinylphosphonate, diallyl vinylphosphonate, diethynyl vinylphosphonate, dipropagyl vinylphosphonate, dimethyl allylphosphonate, diethyl allylphosphonate, dipropyl allylphosphonate, divinyl allylphosphonate, diallyl allylphosphonate, diethynyl allylphosphonate, dipropagyl allylphosphonate, and a derivative thereof, but not limited thereto with the proviso that formula (2) is satisfied. These contribute more to further improvements in the energy efficiency of a lithium air battery.

The phosphoric acid ester having formula (1) and the phosphonic acid ester having formula (2) may be employed in combination due to their high miscibility.

The inventive electrolyte, free of water as described above, is preferably controlled to a water content of 0 ppm to 100 ppm inclusive, including adsorbed water. Within this range, the inventive electrolyte prevents oxidation of the metallic negative electrode when used with a lithium air battery. More preferably, the water content of the electrolyte is controlled to 50 ppm or lower.

While the inventive electrolyte contains lithium nitrate in high concentrations, it is preferable to have a viscosity in the range of 0.1 Pa·s to 10 Pa·s inclusive. As the viscosity is adjusted in this range, it contributes to enhanced energy efficiency. More preferably, the inventive electrolyte has a viscosity in the range of 0.5 Pa·s to 5 Pa·s inclusive as it contributes more to enhanced energy efficiency. Most preferably, the inventive electrolyte has a viscosity in the range of 0.5 Pa·s to 2 Pa·s inclusive. While the viscosity of the electrolyte may be measured by a viscometer, it is understood that if the electrolyte has visibly observable fluidity, it may be judged as having a viscosity in the range of 0.1 Pa·s to 10 Pa·s inclusive.

The inventive electrolyte may further contain an organic matter (also called an additive) selected from the group of an aromatic hydrocarbon, a halogenated alkyl, and a halogenated ether. If these organic matters are added to the electrolyte, it is then possible to adjust its viscosity without having any significant influence on its performance.

The aforesaid organic matter may preferably be contained in a range of 1% by volume to 70% by volume inclusive with respect to the organic solvent. This allows for viscosity adjustment. More preferably, the aforesaid organic matter may be contained in the range of 5% by volume to 20% by volume inclusive. This is useful for enhanced energy efficiency while gaining adjustment of viscosity. Most preferably, the aforesaid organic matter is contained in the range of 5% by volume to 10% by volume inclusive.

The process for producing the electrolyte according to the invention will now be explained.

The inventive electrolyte is preferably produced by mixing the aforesaid organic solvent with lithium nitrate such that the aforesaid molar concentration is satisfied. It is here noted that while mixing may be manually carried out, it is preferable to implement mixing by use of a mixer such as a stirrer or a propeller, thereby promoting dissolution. It is understood that the mixture may be heated at 40° C. to 80° C. inclusive thereby promoting dissolution. If the dispersion of lithium nitrate is not visibly observed, it would be reasonable to judge that dissolution has already taken place.

Lithium nitrate, because of having deliquescence, is preferably weighed and mixed with the organic solvent in a glove box, thereby preventing adsorption of water. Prior to mixing, lithium nitrate is further preferably dehydrated by vacuum drying, thereby controlling the content of adsorbed water to 100 ppm or lower. Alternatively, the organic solvent may previously be dehydrated by a molecular sieve.

It is here noted that mixing may further be carried out with the addition of an organic matter selected from the group consisting of an aromatic hydrocarbon, a halogenated alkyl, and a halogenated ether as mentioned above, thereby controlling the viscosity of the resultant electrolyte in the range of 0.1 Pa·s to 10 Pa·s inclusive. As described above, the organic matter is mixed in an amount of preferably 1% by volume to 70% by volume inclusive, more preferably 5% by volume to 20% by volume inclusive, and most preferably 5% by volume to 10% by volume inclusive relative to the organic solvent.

Because the inventive electrolyte is obtained by simple mixing of the starting materials, the present invention can be easily implemented with no need of using any special equipment or any special technique.

### (Implementation Mode 2)

A lithium air battery making use of the electrolyte explained in Implementation Mode 1 will now be described with reference to Implementation Mode 2.

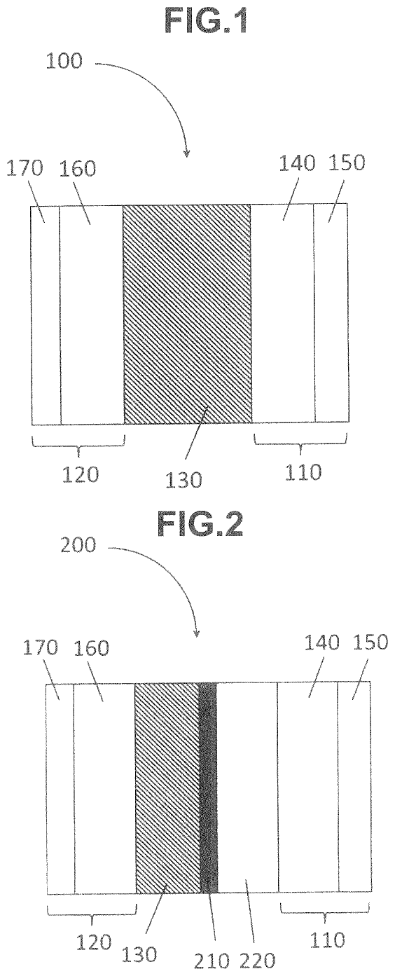

FIG. 1 is a schematic view of the arrangement of the inventive lithium air battery.

The inventive lithium air battery 100 comprises an air electrode 110, a metallic negative electrode 120 comprising a lithium metal, and an electrolyte 130 positioned between the air electrode 110 and the metallic negative electrode 120. It is here understood that the electrolyte 130, because of being the one explained with reference to Implementation Mode 1, will not be described anymore. According to the invention, it is possible to provide a lithium air battery having enhanced energy efficiency due to the use of the electrolyte explained with reference to Implementation Mode 1.

The air electrode 110 comprises a positive electrode reaction layer 140, and a positive electrode collector 150 contiguous or adjacent thereto. Although the positive electrode reaction layer 140 is mainly composed of a porous carbon material, it may further contain a catalyst, a binder, a conductive assistant and so on, if required. The porous carbon material includes, but not limited to, mesoporous carbon, graphene, carbon black, acetylene black, carbon nanotubes, carbon nanofibers, carbon nanohorns, etc. Formed of a metallic material, carbon or the like having a combination of porosity and electrical conductivity, the positive electrode collector 150 may have an externally connected terminal (not shown). Materials well known in the art may be used for the catalyst, binder and conductive assistant.

The metallic negative electrode 120 comprises a lithium metal-containing negative electrode active substance layer 160, and a negative electrode collector 170 contiguous or adjacent thereto. The lithium metal contained in the negative electrode active substance layer 160 may be either a single lithium metal or a lithium alloy. The element that forms a lithium alloy with lithium includes, but not limited to, magnesium, titanium, tin, lead, aluminum, indium, silicon, zinc, antimony, bismuth, gallium, germanium, yttrium and so on. As is the case with the positive electrode collector 150, the negative electrode collector 170 is formed of an electrically conductive material such as a metallic material or carbon, and may have an externally connected terminal (not shown). For instance, the negative electrode active substance layer 160 may be integral with the negative electrode collector 170.

Although the inventive lithium air battery 100 operates on the same principles as an existing lithium air battery, it is understood that the energy efficiency can grow dramatically high by use of the electrolyte 130 explained with reference to Implementation Mode 1. Although not shown, a separator (not shown) incapable of reacting with the electrolyte 130 of the lithium air battery 100 may be immersed or dipped in this electrolyte such that it is positioned between the air electrode 110 and the metallic negative electrode 120. Materials well-known in the art may be used for such a separator.

FIG. 2 is a schematic view of the arrangement of another lithium air battery according to the invention.

The lithium air battery 200 of FIG. 2 is similar to the lithium air battery 100 of FIG. 1 except that it comprises a separator 210 capable of lithium ion conduction between the air electrode 110 and the metallic negative electrode 120, and an electrolyte 220 between the separator 210 and the air electrode 110.

It is here understood that any material capable of lithium ion conduction and impervious to a liquid such as water may be applied to the separator 210. For instance, use may be made of a variety of materials including an insulating porous material referred to in Patent Publication 1, and a variety of materials including a separation film referred to in JP(A) 2012-227119. The electrolyte 220 may be either the one explained with reference to Implementation Mode 1 or an aqueous electrolyte. Although an electrolyte usually used with a lithium air battery may be used as the aqueous electrolyte, an aqueous electrolyte disclosed typically in JP(A) 2012-227119 may be used. Such an arrangement allows for a reduced or limited mixing of the electrolyte between the air electrode 110 and the metallic negative electrode 120, which activates battery reaction, leading to the provision of high capacity batteries.

The lithium air battery 100, 200 assembled as shown in FIGS. 1 and 2 may be encapsulated in a case made up of a laminate film formed of a thermoplastic resin or the like or, alternatively, it may be laminated one upon another as would be apparent to those skilled in the art.

Although the invention is applied to lithium air batteries, it is understood that the inventive electrolyte may be applied to the electrolytes of other metallic air batteries, secondary batteries, and fuel batteries.

The present invention will now be explained in further details with reference to some specific examples; however, it should be noted that the invention is not limited to these examples.

### EXAMPLES

### Examples 1 to 17

In Examples 1 to 17, electrolytes containing a variety of organic solvents comprising phosphoric acid esters and phosophonic esters and a variety of lithium salts were prepared to produce lithium air batteries (coin cells) which were then estimated in terms of their electrochemical characteristics, as detailed below.

Triethyl phosphate (TEP), tripropyl phosphate (TPP), tributhyl phosphate (TBP), and triisopropyl phosphate (TIPP) used herein as the phosphoric acid esters were purchased from Tokyo Chemical Industry Co., Ltd. Diethyl methylphosphonate (DEMP) and diethyl ethylphosphonate (DEEP) used herein as the phosphonic acid esters were purchased from Tokyo Chemical Industry Co., Ltd. The organic solvents were dehydrated by a molecular sieve, if required. For reference, the structural formulae of these organic solvents are given just below.

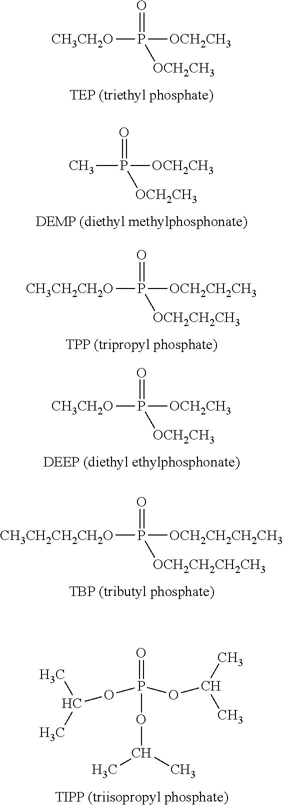

Lithium nitrate (LiNO₃ made by Sigma-Aldrich Japan), lithium bis(fluorosulfonyl)imide (LiFSI made by KISHIDA CHEMICAL Co., Ltd.), and lithium tetrafluoroborate (LiBF₄ made by KISHIDA CHEMICAL Co., Ltd.) were used as the lithium salt. The lithium salts were vacuum-dried for dehydration, if required.

Various lithium salts were weighed and mixed with various organic solvents (2 mL) in a glove box in such a way as to satisfy the concentrations set forth in Table 1. After mixing, the mixture was agitated using a magnetic stirrer at room temperature (25° C.). In all the electrolytes obtained in Examples 1 to 17, the lithium salt was fully dissolved; in other words, there was neither precipitation nor dispersion of the lithium salt observed. The resultant electrolyte was found to have a water content of 100 ppm or lower as measured by a Karl Fischer's moisture analyzer. There was also a visibly observed flow of the electrolyte; in other words, the viscosity of the electrolyte was determined as being in the range of 0.1 Pa·s to 10 Pa·s inclusive.

TABLE 1
Listing of the Electrolytes of Examples 1-17

| Ex. | Organic | Supporting Salt | |
|---|---|---|---|
| No. | Solvent | Type | Conc. (mol/L) |
| 1 | TEP | LiNO₃ | 1 |
| 2 | TEP | LiNO₃ | 3 |
| 3 | TEP | LiFSI | 1 |
| 4 | TEP | LiSFI | 5 |
| 5 | TEP | LiBF₄ | 1 |
| 6 | TEP | LiBF₄ | 5 |
| 7 | TPP | LiNO₃ | 1 |
| 8 | TPP | LiNO₃ | 2 |
| 9 | TPP | LiNO₃ | 4 |
| 10 | TBP | LiNO₃ | 1 |
| 11 | TBP | LiNO₃ | 3 |
| 12 | TIPP | LiNO₃ | 1 |
| 13 | TIPP | LiNO₃ | 2 |
| 14 | DEMP | LiNO₃ | 1 |
| 15 | DEMP | LiNO₃ | 4 |
| 16 | DEEP | LiNO₃ | 1 |
| 17 | DEEP | LiNO₃ | 4 |

For TEP, TBP, TIPP, DEMP, and DEEP, see [0045].

Then, the electrolytes of Examples 1 to 17 were each used to assemble a CR2032 type coin cell as the lithium air battery. Ketjen black (registered trademark) (EC600JD made by Lion Specialty Chemicals Co., Ltd.) or a sort of carbon black was used for the air electrode, and a lithium metal foil (016 mm) was used for the metallic negative electrode. More specifically, 0.105 gram of Ketjen black, 0.090 gram of an aqueous solution of 5% by weight polyvinyl pyrrolidone (K90 made by FUJIFILM Wako Pure Chemical Corporation) serving as a dispersant and 2.238 grams of ultrapure water were mixed together and stirred for 3 minutes. Then, 0.068 gram of polytetrafluoroethylene or PTFE (POLYFLON PEFE D-210C made by DAIKIN industries, Ltd.) was added to the mixture and stirred for an additional 3 minutes. The obtained slurry was coated on carbon paper (TGP-H-060 made by Toray Industries, Inc.), and vacuum-dried at 110° C. for 15 hours. The obtained carbon paper was punched out into ϕ16 mm. In this way, there was an air electrode obtained, in which Ketjen black forming a positive electrode reaction layer was imparted to the carbon paper forming a positive electrode collector. On the other hand, a lithium foil (ϕ16 mm and 0.2 mm thick) which functions both as a negative electrode active substance and as a negative electrode collector was used as a metallic negative electrode.

The aforesaid air electrode, metallic negative electrode and glass fiber paper (Whatman (registered trademark), GF/A)) that was a separator impregnated with each of the electrolytes according to Examples 1 to 17 were encapsulated in a coin cell case (CR2032 type). Note here that prior to encapsulation, a plurality of air-sucking/discharging small holes (ϕ1 mm) were formed in the surface of the air electrode of the coin cell case.

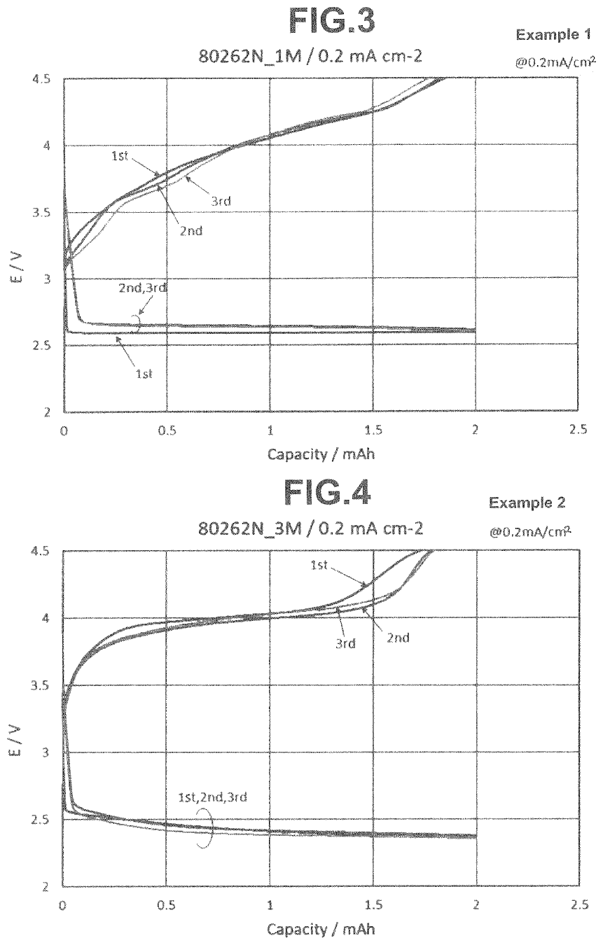

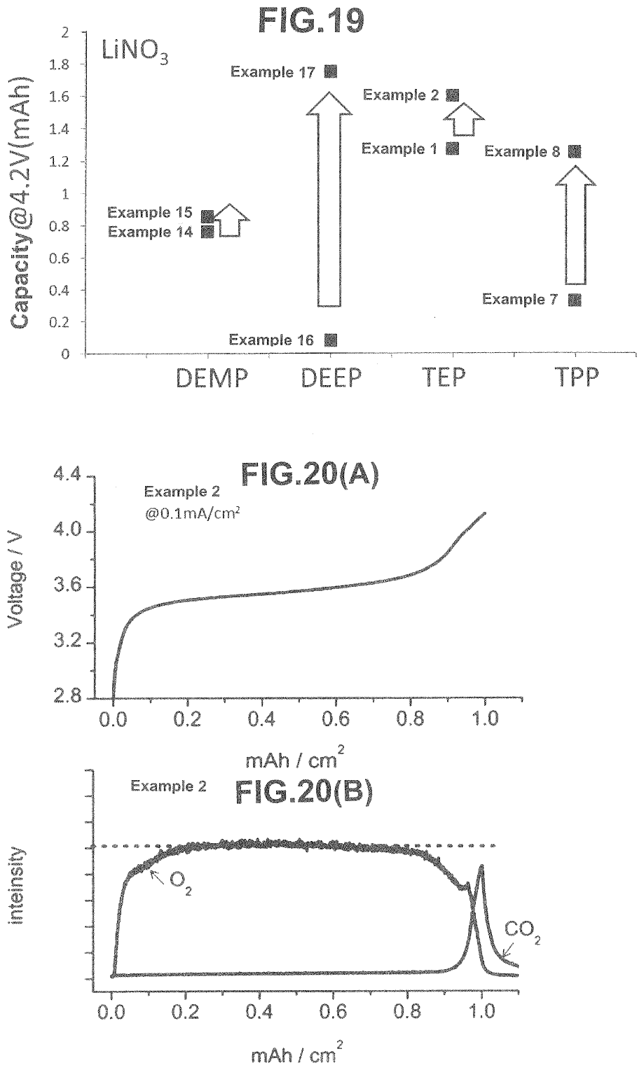

The thus obtained lithium air batteries using the electrolytes according to Examples 1 to 17 were estimated in terms of cycle characteristics. Specifically, a five-hour discharge/five-hour charge cycle was repeated three times at a current value of 0.1 mA/cm², 0.2 mA/cm² or 0.4 mA/cm² and a cutoff potential of 2 to 4.5 V in an oxygen atmosphere at room temperature. A charge/discharge tester (HJ1001SD8 made by HOKUTO DENKO Corporation) was used for this measurement. The results are shown in FIGS. 3 to 17. For comparison, the capacity of the battery at 4.2 V in the 3rd cycle charge phase was also determined. The results are shown in FIGS. 18 and 19, and in Table 2. In addition, the mass spectrometry (MS analysis using M-4010GA-DM made by Canon Anelba Co., Ltd.) of gases generated out of the charge reaction was in situ carried out. The results of the lithium air battery according to Example 2 are shown in FIG. 20(B).

FIG. 3 is indicative of the charge/discharge cycle characteristics of the lithium air battery according to Example 1.

FIG. 4 is indicative of the charge/discharge cycle characteristics of the lithium air battery according to Example 2.

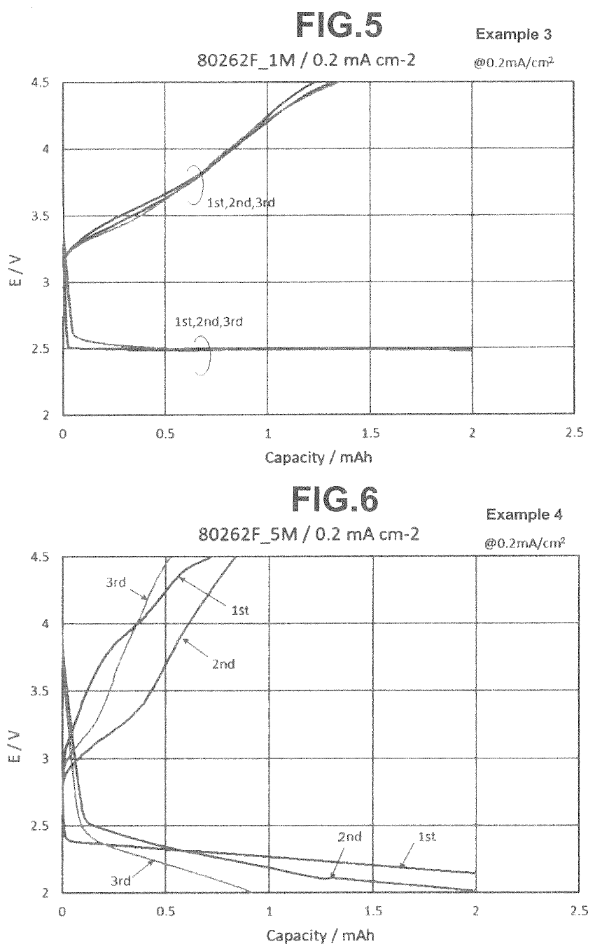

FIG. 5 is indicative of the charge/discharge cycle characteristics of the lithium air battery according to Example 3.

FIG. 6 is indicative of the charge/discharge cycle characteristics of the lithium air battery according to Example 4.

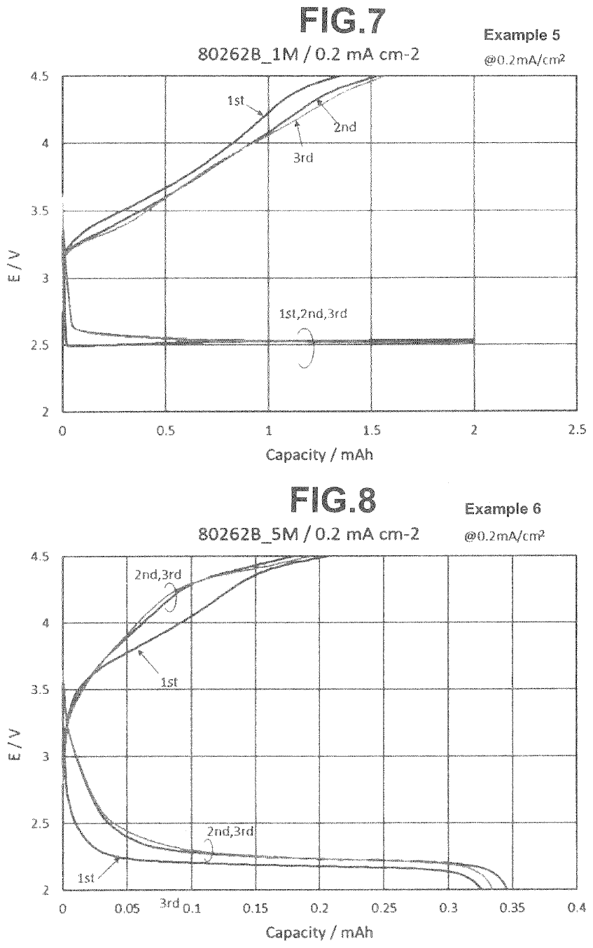

FIG. 7 is indicative of the charge/discharge cycle characteristics of the lithium air battery according to Example 5.

FIG. 8 is indicative of the charge/discharge cycle characteristics of the lithium air battery according to Example 6.

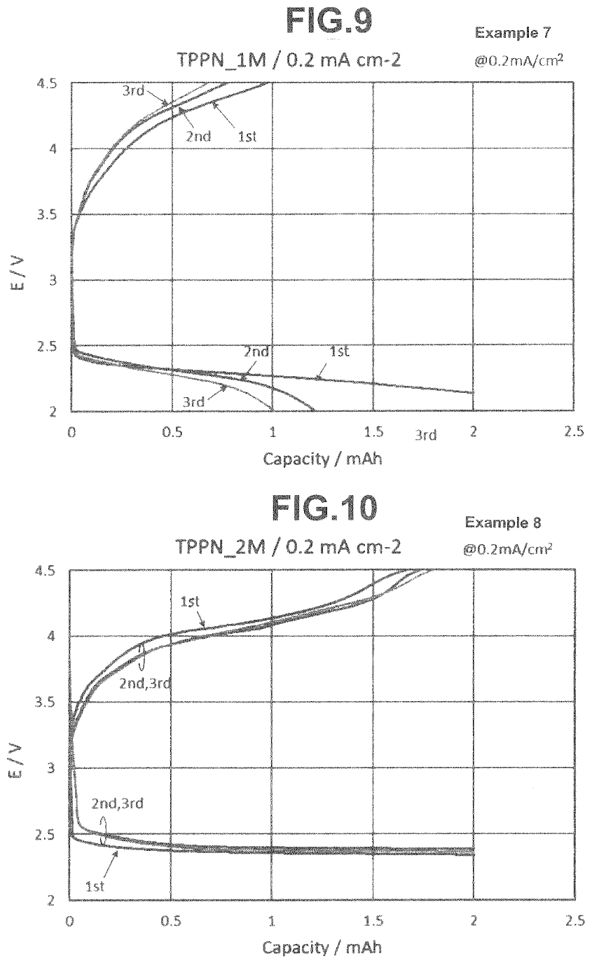

FIG. 9 is indicative of the charge/discharge cycle characteristics of the lithium air battery according to Example 7.

FIG. 10 is indicative of the charge/discharge cycle characteristics of the lithium air battery according to Example 8.

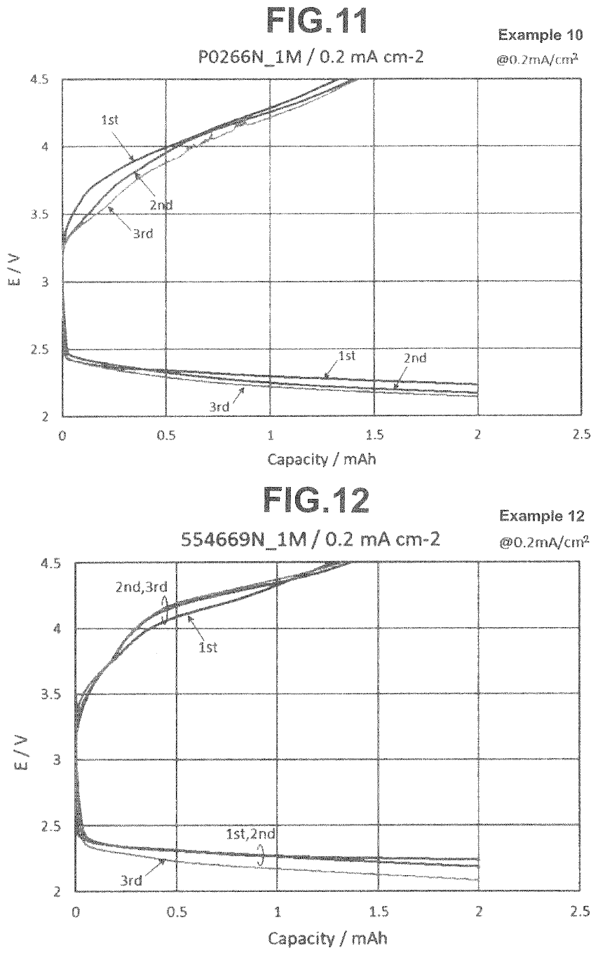

FIG. 11 is indicative of the charge/discharge cycle characteristics of the lithium air battery according to Example 10.

FIG. 12 is indicative of the charge/discharge cycle characteristics of the lithium air battery according to Example 12.

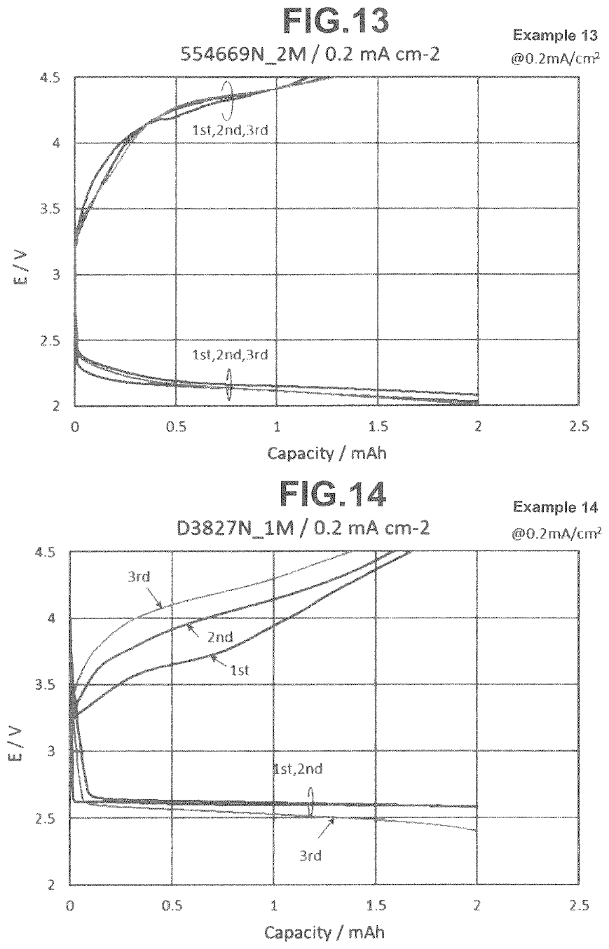

FIG. 13 is indicative of the charge/discharge cycle characteristics of the lithium air battery according to Example 13.

FIG. 14 is indicative of the charge/discharge cycle characteristics of the lithium air battery according to Example 14.

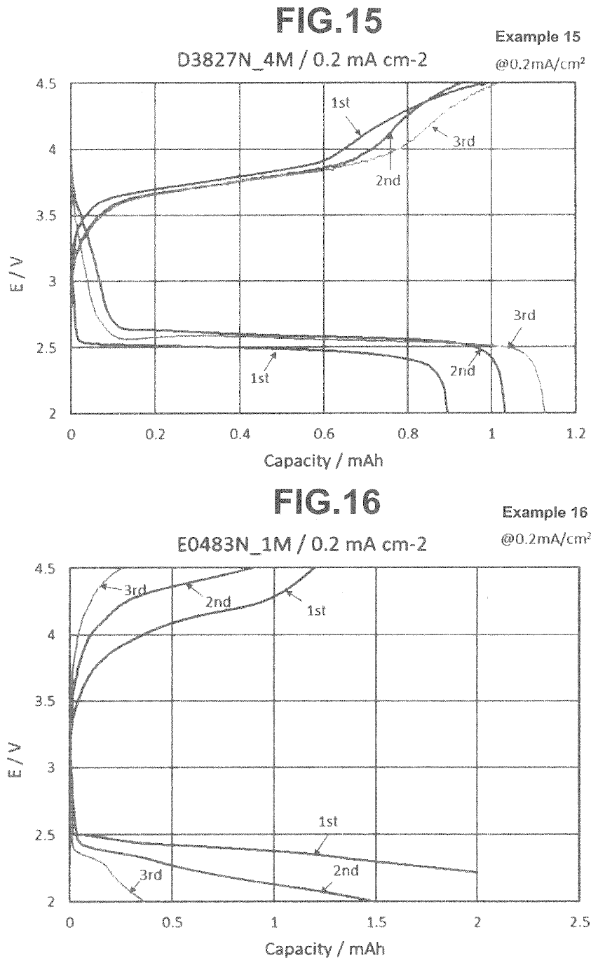

FIG. 15 is indicative of the charge/discharge cycle characteristics of the lithium air battery according to Example 15.

FIG. 16 is indicative of the charge/discharge cycle characteristics of the lithium air battery according to Example 16.

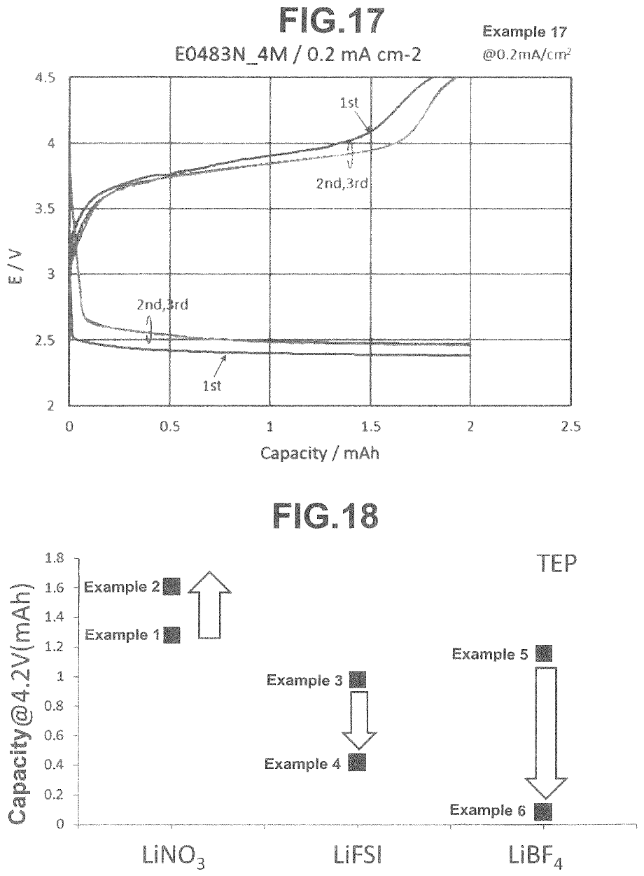

FIG. 17 is indicative of the charge/discharge cycle characteristics of the lithium air battery according to Example 17.

According to FIG. 5 to FIG. 8, it has been found that with the electrolytes comprising TEP combined with lithium salt LiFSI or LiBF₄, no consistent charge/discharge cycle characteristics were obtained irrespective of the type and concentration of the lithium salt. According to FIGS. 3, 4, 9 and 10, on the other hand, it has been found that with the electrolytes comprising TEP or TPP combined with lithium nitrate as the lithium salt, consistent charge/discharge cycle characteristics are obtained. More surprisingly, it has been observed that as the concentration of lithium nitrate, it prevents any increase in the voltage of the air electrode during charge, leading to more enhanced energy efficiency. Although not shown, the battery using the electrolyte according to Example 9 increases more in terms of energy efficiency, indicating that lithium nitrate is more preferably contained in higher concentrations. According to FIG. 11, however, no consistent charge/discharge cycle characteristics are obtained with the electrolyte comprising TBP combined with lithium nitrate. Although not shown, even with the electrolyte of Example 11 having an increased concentration of lithium nitrate, no increase in energy efficiency was observed at all.

According to FIG. 12 and FIG. 13, it has also been found that with the electrolytes comprising TIPP combined with lithium nitrate, no consistent charge/discharge cycle characteristics are obtained irrespective of the concentration of lithium nitrate. This would suggest that the respective hydrocarbon groups in formula (1) are not only limited in terms of the number of carbon atoms but also limited to a linear form rather than a branched or other complicated form.

These results have shown that in electrolytes comprising the phosphoric acid ester combined with lithium nitrate, the phosphoric acid ester should be selected from what is represented by formula (1): R1, R2 and R3 should be selected from linear alkyl, alkenyl, and alkynyl groups having up to 3 carbon atoms or derivatives thereof, and that when the concentration of lithium nitrate is equal to or more than 2 mol/L, the energy efficiency of an air battery grows high.

According to FIG. 14 to FIG. 17, it has been seen that in the electrolytes comprising DEMP or DEEP combined with lithium nitrate, increased concentrations of lithium nitrate serve well to hold back any increase in the voltage of the air electrode during charge, resulting in dramatically enhanced energy efficiency.

From these results, it has been shown that in electrolytes comprising a phosphonic acid ester combined with lithium nitrate, the phosphonic acid ester should be selected from what is represented by formula (2): R1, R2 and R3 should be selected from linear alkyl, alkenyl, and alkynyl groups having up to 3 carbon atoms or derivatives thereof, and that when the concentration of lithium nitrate is equal to or more than 2 mol/L, the energy efficiency of an air battery grows high.

TABLE 2
Listing of capacities of air batteries (cell
batteries) using the electrolytes of Examples 1 to 17 as
measured at 4.2 V in the 3^{rd} charge cycle

| | | | | Capacities at |
|---|---|---|---|---|
| | | | | 4.2 V in the |
| Ex. | Organic | Supporting Salt | | 3^{rd} charge |
| No. | Solvent | Type | Conc. (mol/L) | cycle (mAH) |
| 1 | TEP | LiNO₃ | 1 | 1.277 |
| 2 | TEP | LiNO₃ | 3 | 1.607 |
| 3 | TEP | LiFSI | 1 | 0.983 |
| 4 | TEP | LiSFI | 5 | 0.417 |
| 5 | TEP | LiBF₄ | 1 | 1.160 |
| 6 | TEP | LiBF₄ | 5 | 0.080 |
| 7 | TPP | LiNO₃ | 1 | 0.330 |
| 8 | TPP | LiNO₃ | 2 | 1.260 |
| 9 | TPP | LiNO₃ | 4 | — |
| 10 | TBP | LiNO₃ | 1 | 0.974 |
| 11 | TBP | LiNO₃ | 3 | — |
| 12 | TIPP | LiNO₃ | 1 | 0.513 |
| 13 | TIPP | LiNO₃ | 2 | 0.410 |
| 14 | DEMP | LiNO₃ | 1 | 0.760 |
| 15 | DEMP | LiNO₃ | 4 | 0.857 |
| 16 | DEEP | LiNO₃ | 1 | 0.083 |
| 17 | DEEP | LiNO₃ | 4 | 1.757 |

FIG. 18 is indicative of capacity changes at 4.2 V during charge of lithium air batteries making use of electrolytes comprising TEP in combination with various lithium salts.

FIG. 19 is indicative of capacity changes at 4.2 V during charge of lithium air batteries making use of electrolytes comprising DEMP, DEEP, TEP and TPP each combined with lithium nitrate.

According to FIG. 18, it has been identified that when TEP of the phosphoric acid esters is used, use of lithium nitrate as the lithium salt in a high concentration range of 2 mol/L to 5.5 mol/L inclusive, and preferably 3 mol/L to 5.5 mol/L inclusive results in an increased capacity. It has also been found that when the lithium salt is LiFSI or LiBF₄, its behavior is quite opposite to that of lithium nitrate. This would indicate that an increase in the capacity in association with an increasing lithium salt concentration is a phenomenon unique to lithium nitrate.

According to FIG. 19, it has been identified that when DEMP and DEEP are used as the phosphonic acid ester and TPP is used as the phosphoric acid ester, use of lithium nitrate as the lithium salt in a high concentration range of 2 mol/L to 5.5 mol/L inclusive, preferably 3 mol/L to 5.5 mol/L inclusive, and more preferably 4 mol/L to 5 mol/L inclusive results in a significantly increased capacity, as is the case with FIG. 18. It has again been shown that when TEP is used as the phosphoric acid ester, it is preferable to use lithium nitrate as the lithium salt in a high concentration.

FIG. 20(A) is indicative of a charge curve of the lithium air battery according to Example 2 and FIG. 20(B) is indicative of the results of mass spectrometry of gases generated from an associated charging reaction.

According to FIG. 20(A), the charging reaction made stable progress as in FIG. 4. More specifically, the charging reaction made progress in the vicinity of 3.5 V to 3.6 V at a current density of 0.1 mA/cm². This would be due to the progress of the decomposition reaction of Li₂O₂ via the redox mediator mechanism by NO₂⁻/NO₂.

FIG. 20(B) is indicative of the results of mass spectrometry of gases generated from the charging reaction. According to FIG. 20(B), oxygen equivalent to a theoretical value (indicated by a dotted line) was generated through most of the charging reaction. However, the amount of generated oxygen (O₂) dropped rapidly from the immediate vicinity of a charging voltage 4.0 V, leading to an increase in the amount of carbon dioxide (CO₂) generated. Understandably, the then generated carbon dioxide was stemmed from carbon used as part of the air electrode, as can be seen from the results of isotopic analysis. This would show that if the inventive electrolyte is used with a lithium air battery, high reaction reversibility can then be achieved in a voltage region of up to 4 V.

As described above, it has been shown that by use of an electrolyte comprising an organic solvent that is a phosphoric acid ester selected out of various phosphoric acid esters and represented by the aforesaid formula (1) and a phosphonic acid ester selected out of various phosphonic acid esters and represented by the aforesaid formula (2), and lithium nitrate selected out of various lithium salts, and that has a lithium nitrate concentration (2 mol/L to 5.5 mol/L inclusive) adjusted higher than usual, it is possible to significantly enhance the energy efficiency of a lithium air battery. A variety of phosphoric acid esters and a variety of lithium salts are enumerated in Patent Publication 1. As a result of trials and errors, the present inventor has selected the aforesaid only limited combinations from such innumerable combinations and adjusted lithium nitrate to a predetermined high concentration, successfully ending up with a particular effect on improvements in the energy efficiency of air batteries.

### INDUSTRIAL APPLICABILITY

The electrolyte according to the invention is applied to a lithium air battery for the purpose of improving its energy efficiency.

### EXPLANATION OF THE REFERENCE NUMERALS

100, 200: lithium air battery, 110: air electrode, 120: metallic negative electrode, 130, 220: electrolyte, 140: positive electrode reaction layer, 150: positive electrode collector, 160: negative electrode active substance layer, 170: negative electrode collector, 210: separator

1. An electrolyte for lithium air batteries containing: an organic solvent that is a phosphoric acid ester and/or phosphonic acid ester, and lithium nitrate, characterized in that:
a concentration of the lithium nitrate in the organic solvent satisfies a range of 2 mol/L to 5.5 mol/L inclusive, and
the phosphoric acid ester is represented by the following chemical formula (1), and the phosphonic acid ester is represented by the following chemical formula (2): 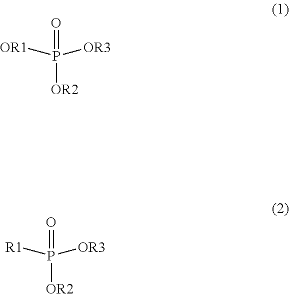
where R1, R2 and R3 are each independently a group selected from the group consisting of a linear alkyl group having one to three carbon atoms, a linear alkenyl group having two or three carbon atoms, an alkynyl group having two or three carbon atoms, and a derivative thereof.

2. The electrolyte according to claim 1, wherein the concentration of the lithium nitrate in the organic solvent satisfies a range of 3 mol/L to 5.5 mol/L inclusive.

3. The electrolyte according to claim 2, wherein the concentration of the lithium nitrate in the organic solvent satisfies a range of 4 mol/L to 5.5 mol/L inclusive.

4. The electrolyte according to claim 1, wherein the alkyl group is selected from the group consisting of a methyl group, an ethyl group, and an n-propyl group,
the alkenyl group is a vinyl group or an allyl group, and
the alkynyl is an ethynyl group or a propargyl group.

5. The electrolyte according to claim 1, wherein the phosphoric acid ester is at least one selected from the group consisting of trimethyl phosphate, triethyl phosphate, tripropyl phosphate, trivinyl phosphate, triallyl phosphate, triethynyl phosphate, tripropargyl phosphate, and a derivative thereof.

6. The electrolyte according to claim 5, wherein the phosphoric acid ester is at least one selected from the group consisting of triethyl phosphate, tripropyl phosphate, and a derivative thereof.

7. The electrolyte according to claim 1, wherein the phosphonic acid ester is at least one selected from the group consisting of dimethyl methylphosphonate, diethyl methylphosphonate, dipropyl methylphosphonate, divinyl methylphosphonate, diallyl methylphosphonate, diethynyl methylphosphonate, dipropargyl methyl-phosphonate, dimethyl ethylphosphonate, diethyl ethylphosphonate, dipropyl ethylphosphonate, divinyl ethylphosphonate, diallyl ethylphosphonate, diethynyl ethylphosphonate, dipropargyl ethylphosphonate, dimethyl propylphosphonate, diethyl proylphosphonate, dipropyl propylphosphonate, divinyl propylphosphonate, diallyl propylphosphonate, diethynyl propylphosphonate, dipropargyl propylphosphonate, dimethyl vinylphosphonate, diethyl vinylphosphonate, dipropyl vinylphosphonate, divinyl vinylphosphonate, diallyl vinylphosphonate, diethynyl vinylphosphonate, dipropargyl vinylphosphonate, dimethyl allylphosphonate, diethyl allylphosphonate, dipropyl allylphosphonate, divinyl allylphosphonate, diallyl allylphosphonate, diethynyl allylphosphonate, dipropargyl allylphosphonate, and a derivative thereof.

8. The electrolyte according to claim 7, wherein the phosphonic acid ester is at least one selected from the group consisting of diethyl methylphosphonate, diethyl ethylphosphonate, and a derivative thereof.

9. The electrolyte according to claim 1, wherein the water contained in the electrolyte is up to 100 ppm.

10. The electrolyte according to claim 1, wherein the electrolyte has a viscosity ranging from 0.1 Pa·s to 10 Pa·s inclusive.

11. A lithium air battery comprising an air electrode, a metallic negative electrode including a lithium metal, and a non-aqueous electrolyte positioned between the air electrode and the metallic negative electrode, wherein the non-aqueous electrolyte is the electrolyte according to claim 1.

12. The lithium air battery according to claim 11, which comprises a separator between the air electrode and the metallic negative electrode,
the non-aqueous electrolyte between the metallic negative electrode and the separator, and
the non-aqueous electrolyte or an aqueous electrolyte between the air electrode and the separator.
